(19) United States
(12) Patent Application Publication
(10) Pub. No.: US 2016/0055597 A1
(43) Pub. Date: Feb. 25, 2016

(54) REPUTATION SCORING SYSTEM FOR PROJECT BASED PROFESSIONALS

(71) Applicants: Kevin BERSON, Sherman Oaks, CA (US); Joesph Christian GAMMILL, (US); Christopher RAMPEY, Bellevue, WA (US)

(72) Inventors: KEVIN BERSON, SHERMAN OAKS, CA (US); JOESPH CHRISTIAN GAMMILL, HUNTINGTON BEACH, CA (US); CHRISTOPHER RAMPEY, BELLEVUE, WA (US)

(21) Appl. No.: 14/777,387

(22) PCT Filed: May 17, 2014
(86) PCT No.: PCT/US14/38521

§ 371 Date: Sep. 15, 2015

Related U.S. Application Data
(60) Provisional application No. 61/824,943, filed on May 17, 2013.
(60) Provisional application No. 61/824,935, filed on May 17, 2013.
(60) Provisional application No. 61/824,956, filed on May 17, 2013.
(60) Provisional application No. 61/824,961, filed on May 17, 2013.

(51) Int. Cl. G06Q 50/00; G06F 17/30

(52) U.S. Cl. CPC G06Q 50/01; G06F 17/30864

(57) ABSTRACT

A reputation scoring system for project based professionals is provided. The reputation scoring system (400) may analyze public data points (410) and private data points (420) from external platforms for providing a new user a reputation score prior to active engagement on the platform. As the user interacts within the platform and with its community, the user's reputation may be dynamically updated.

### CROSS-REFERENCE TO RELATED APPLICATIONS

This application claims the benefit of U.S. Provisional Application 61/824,935, entitled “Multimedia Content Collections”, filed May 17, 2013, U.S. Provisional Application 61/824,943, entitled “Multivariate Reputation Scoring System for Content Creators”, filed May 17, 2013, U.S. Provisional Application 61/824,956, entitled “Multi-Faceted, Multi-Media, High-Relevancy Knowledge Database”, filed May 17, 2013, and U.S. Provisional Application 61/824,961, entitled “Talent Sourcing System for Content Creators”, filed May 17, 2013, which are incorporated herein by reference.

### FIELD OF INVENTION

The present disclosure generally relates to assessing and dynamically monitoring a reputation and/or talent score for content creators in the creative services industry.

### BACKGROUND

Currently, it is very difficult to assess the reputation of a member of the creative community outside of Internet Movie Database (“IMDB”) credits, which provide a limited measure of one's talent. Furthermore, most assessments fail to factor in a complete view of one's experience, network, network participation, or index of performance relative to the current years in the creative services business.

One of the biggest challenges in the creative process is finding the right balance of quality, price and ‘fit’ for staffing a creative project. Many concerns about levels of transparency, competency and grit (overall work ethic, commitment, etc.) are difficult to qualitatively determine for any particular content creator.

Additionally, when creative professionals scour the internet in a time-sensitive search for critical information (how to use a piece of software, what equipment to use & when, etc.), existing forums can become a quagmire of information overdose largely comprised of outdated, insufficient or incorrect information. In these instances, the quality or knowledge of the feedback provided by individuals is not vetted, nor can one ascertain the level of expertise or reputation for providing feedback on those forums.

Usually there are several individuals involved in the content creation process (e.g. directors, producers, actors, writers, editors, make-up artists, sound mixers, set designers, costume designers, lighting crew, location scouters, etc.). Allowing these individuals to comment and provide feedback and highly relevant information about their work may allow content creators to better evaluate peers and provide input for which a better evaluation of expertise, talents, and/or general reputation in the industry can be ascertained.

One major drawback and bather in participating in reputation based communities includes the need for active engagement and involvement in the community to build a reputation over time. Thus, early adopters may end up with higher reputation scores over time compared to new adopters who have valid and long standing experience and expertise in the content creation industry.

For these reasons, there exists a need for an integrated platform that allows content creators to exchange ideas in a media rich environment, provide visually rich commentary on work product, and combine previously known qualities, achievements, and skills to provide an initial reputation score within the integrated solution to create accurate evaluations of new content creators within the platform.

### BRIEF SUMMARY

Some embodiments provide a system and method for a reputation scoring system for project based professionals such as content creators.

An initial community reputation score may be assessed when a new user account is created. During the creation process external data repositories can be identified. The external data repositories may include public and private data points about the user (e.g., publicly available data for content creators such as IMDB and professional and social networking websites protected with user login information). Publicly available information may be scraped from the external data repositories. Profile data from private external data repositories may be scraped and/or obtained using application programming interface commands. Theses private data repositories may require user account information for accessing the private profile data of the user. The publicly available information and profile data may be aggregated into several data points about the user. The data points may then be analyzed and a reputation score may then be defined based on the analyzed data points.

The preceding Summary is intended to serve as a brief introduction to some embodiments of the present disclosure. It is not meant to be an introduction or overview of all inventive subject matter disclosed in this document. The Detailed Description that follows and the Drawings (or “Figures” or “FIGs.”) that are referred to in the Detailed Description will further describe some of the embodiments described in the Summary as well as other embodiments. Accordingly, to understand all the embodiments described by this document, a full review of the Summary, Detailed Description and the Drawings is needed.

### BRIEF DESCRIPTION OF THE DRAWINGS

The novel features of the disclosure are set forth throughout this specification. However, for purpose of explanation, some embodiments are set forth in the following drawings.

FIG. 1 illustrates an exemplary system that may be used to implement some embodiments;

FIG. 2 illustrates exemplary data points used by some embodiments;

FIG. 3 illustrates a flow chart of an exemplary process used in some embodiments to assess the reputation of a new user on the platform;

FIG. 4 illustrates a block diagram of data sources used for reputation analysis;

FIG. 5 illustrates a block diagram of an exemplary system for implementing an application for assessing a reputation score of some embodiments;

FIG. 6 illustrates an exemplary software architecture of a multivariate reputation score application;

FIG. 7 illustrates a flow chart of an exemplary process used by some embodiments to define and store a multivariate reputation scoring application of some embodiments; and

FIG. 8 illustrates a schematic block diagram of an exemplary computer system with which some embodiments may be implemented.

### DETAILED DESCRIPTION

In the following detailed description, numerous details, examples, and embodiments are set forth and described. However, it will be clear and apparent to one skilled in the art that the disclosure is not limited to the embodiments set forth, and that the disclosed embodiments may be practiced without some of the specific details and examples discussed.

Several more detailed embodiments are described in the sections below. Section I provides an overview description of an exemplary platform for content creators. Section II describes some embodiments of reputation analysis in the system on the platform. Section III describes dynamic reputation monitoring. Section IV describes a system and software architecture used in some embodiments. Lastly, Section V describes a computer system which implements some of the embodiments of the present disclosure.

### I. System Overview

While most platforms limit search to text only or, perhaps, one kind of media (e.g., video but not audio or documents) the present system will, from the outset, allow all users to use the richness of media options (e.g., video, sounds, document uploads, images, and even simple text) to participate. User can post any of the various media types on the platform and then, in other aspects of the site, have lively conversations also with the ability to use the multitude of rich media options (e.g., posting questions or answers that allow for these media types). Using this richness of media, the platform is able to supply the users, upon their query, real-time media-rich search results based upon keyword and meta tag queries.

Some embodiments of the present disclosure provide a platform for a user-base that is an active and aware community keenly interested in getting the most relevant, up-to-date and distilled answers to highly-technical, situational and cutting edge questions. Some embodiments provide a system that is an integrated solution for content creators/collaborators (e.g. directors, producers, actors, writers, editors, make-up artists, sound mixers, set designers, costume designers, lighting crew, location scouters, etc.) to network with other content creators, exchange ideas in a media rich environment, and provide visually rich commentary on work product. The intent is to supply acutely relevant, highly informative and media-rich answers that allow the user base to communicate in the richest possible way.

This platform may allow for deeper conversations between content creators, content curators and the broader industry and fan communities by providing the stakeholders to tell ‘behind the scenes’ stories and/or share relevant materials with each other. Such conversations provide an insight to the rich process of content creation, as told from multiple perspectives. For example, a director might post a picture of a hotel that inspired the setting of a scene is his film or the director may provide details of the locations used and positive and negative aspects about those locations.

These perspectives may take the form of visual annotations to work product, which may be content from an ongoing project or a final video production. The visual annotations may be multimedia objects that could be one or a combination of text, audio, video, PDF files or images that may be visually attached on a video timeline of the content, for example.

Some embodiments of the platform may also provide members the ability to create various collections of content. These collections may take the form of grouping of content accessed either privately (via an invitation) or publicly through searching or browsing the platform. For example, a creative user can create project related collections that may help the creative process at the very beginning a project, collecting items about locations, gear, stories and people that inspire the project. A creative user can also create people related collections where they collect user profiles of people they would like to work with in the future. A creative user can further create location related collections where they collect locations where they would like to shoot in the future. In some embodiments, as the creative user browses the platform, his trail of clicks may be tracked so recently viewed content on the platform can be tracked and added to a new or existing collection.

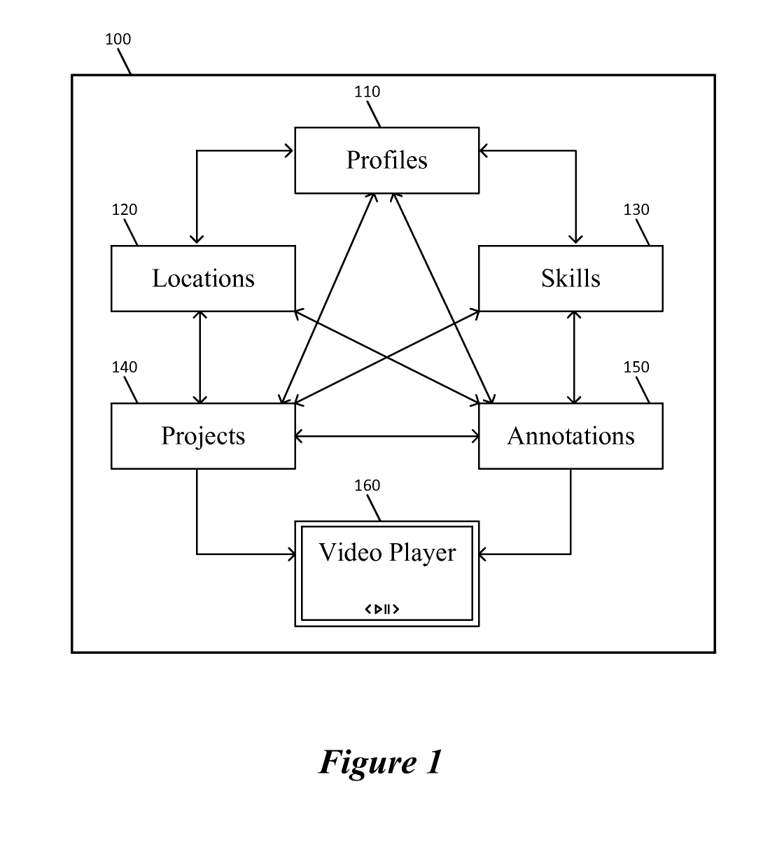

FIG. 1 illustrates an overview of an exemplary system 100 that may be used to implement some embodiments of the present disclosure. The system 100 may include several different interconnected databases including databases for user profiles 110, locations 120, skills 130, work product or projects 140, annotations 150, and a video player 160.

The profiles database 110 include all the profiles that content creators create in the system 100. These profiles can grow over time with annotations made on projects as well as locations and skills used while working on those projects.

The locations database 120 may include several locations identified by content creators that were used during particular shoots. These locations may be linked to projects, multimedia annotations, and/or profiles. Each location in the locations database 120 may also be filled with several types of metadata, tags, and/or attributes of the locations, and other relevant information that may be used by any content creator on the platform while searching for locations to use in a video and/or photography production. For example, the locations may be tagged with geographical identifiers such as zip codes, city, country, etc. as well as location types (e.g., office, home, stadium, church, jail, library, etc.) for easy filtering during a location scouting session. Other relevant information may include availability information, location contact information, images, or any relevant information regarding the capturing of different types of content used in a video production. The system may aggregate several details about locations over time to produce a media rich and detailed repository of locations. The systems and methods by which locations can be identified, attached to content, and scrutinized will be explained in greater detail below.

The skill database 130 may be a database of different skills content creators use in the course of the content creation process. This may not necessarily be related to intangible skills, and could also include the different types of gear/equipment (e.g., cameras, rigs, lighting) or hardware/software that is used during the content creation process. These skills may be linked to annotations on a project which may in turn populate into a content creator's profile to illustrate the level of expertise and use of different skills and/or equipment/gear/software/etc. used during the content creation process. Skills could also include certain types of visual styles and aesthetics that the creator has expertise in e.g. film noir, western, surreal, etc.

The projects database 140 may include all the various types of content uploaded to the system. Throughout this detailed description, projects may be used interchangeably with the terms content, production, video, photography, animation, video game or any combination thereof. Each project may also be associated with several verified content creators. Some of these content creators may have active profiles in the system while others may not. A content creator may be verified as a contributor to the project via a curator in charge of managing content in the system, through a third party such as a studio or verified online database of content creators and their respective work, via a listing of credits from the content itself, by verification provided by a pre-defined number of peers, by the content owner or any other means to verify that the content creator contributed to the production of that content. Once a content creator has been associated as a verified contributor to the content, he or she may contribute to that content by adding rich commentary using multimedia annotations.

Each project in the database 140 may be linked to several profiles (i.e. content creators who worked on that project), locations used to produce the content, skills/equipment used in to shoot the production, as well as all the annotations associated with that project.

The annotations database 150 includes all the multimedia annotations made in the system in association with a project. After creating an annotation the content creator may also be prompted to add tags or associations to the annotation such as location or skills relevant to the particular annotation.

A question/answer database (not shown) may also be provided in some embodiments. Both questions and answers may be ranked based upon their perceived appropriateness and utility. The highest ranked questions and answers may be listed highest in searches on the platform and these rankings may also factor into a reputation score for the participating users. Users may have a full range of multi-media options to choose from in which to better clarify their questions or answers. The system may supply each user with the ability to upload, embed and share text answers, videos, images, sound or documents (PDF, doc, txt, etc.) as they feel are necessary to better pose or answer questions. These submissions can then be ranked by the community as to their usefulness or relevancy, and subsequently affect reputation scores within the platform.

Answers may be edited by the general public and community of users on the platform. In some embodiments, a series of supplied answers might have the complete answer within them and the system may allow editing the highest ranked answer to include information from the other answers in order to make the top answer that much more valuable informative.

Since answers can be ranked based upon appropriateness, the best answers may be presented at the top of all answers. The question originator, community, and/or the public may be able to flag an answer as the most useful to them. This answer would be highlighted as the most valuable to those reviewing the question and serve as the top answer to the posed question.

One of ordinary skills in the art will recognize that the system 100 may be implemented in various different ways without departing from the scope of the disclosure. For instance, some of the databases may be implemented as a single database. In addition, one of ordinary skill in the art will recognize that several other databases or modules may also be incorporated into the system without departing from the scope of the present disclosure. For example, the system may also be further enriched by including a question and answer database related to projects, equipment reviews, general content creation methodologies, a job board, as well as a database of companies that may provide a wide array of services that are needed during the content creation process (e.g. post production, catering, recruiting, etc.). One of ordinary skill will understand that this type of information may easily be included into the system 100 and have linked interconnections with the other several modules or databases within the system 100.

Generally, limiting search queries to overly broad results or limiting conversations and content to just video or text ultimately limits the information available to the end user.

Therefore, to achieve highly relevant search results with the system 100, the system 100 may intentionally limit the user base it is attracting and how that user base can interact with the system. The entire platform may be aimed at a culture of dynamic content creators, for example, professionals and aspiring professionals who are highly active in both the creation and consumption of rich media content. This limited, yet active, user base may allow for inherently refined search results by limiting at the outset what content is actually hosted and curated on the platform.

### II. Reputation Analysis

The present disclosure includes a computer method, system, and program for initial evaluation of a new user's reputation as well as dynamically monitoring and determining a user's community reputation score as the user interacts on the platform. Some embodiments may also match users with ‘ideal’/potential employers (to include collaborators, freelance and full-time positions) and vice versa (match potential employers with ‘best fit’ talent candidates). The methodology described may include monitoring of an exhaustive set of data points captured on the social platform as well as from partner and third party sites such as IMDB, Netflix,

Kickstarter, etc. The data captured may include both static or fixed data points with respect to filmography such as career achievements, awards, nominations, previous projects, companies worked for, dates of employment, and education as well as dynamic or action based user data such as contact form actions, platform level social relationships, and survey responses (e.g., did you hire this person surveys).

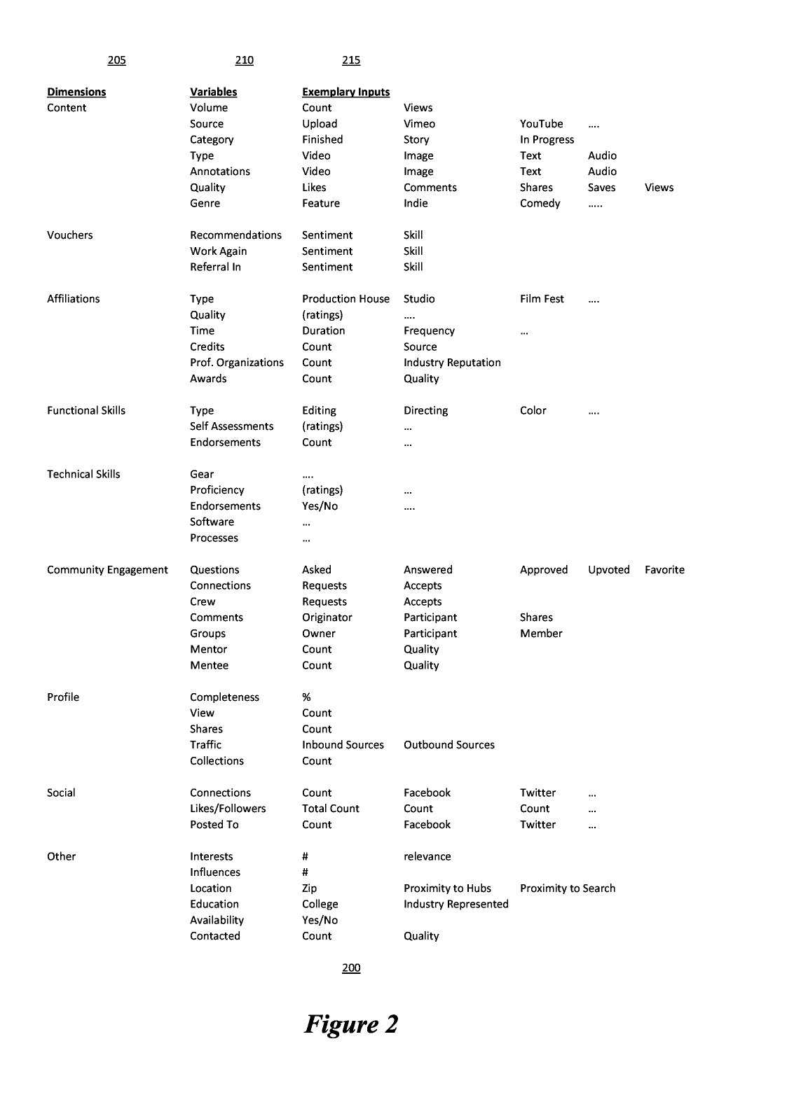

FIG. 2 illustrates a table 200 of exemplary data points that may be captured and monitored for establishing a reputation score on the platform. As illustrated, there may be several dimensional aspects 205 of a reputation score where each dimension 205 may include several variables 210. FIG. 2 further illustrates some exemplary inputs 215 provided for some of the variables.

In some embodiments, a new user on the platform may provide identifiable information and/or login information for third party websites (e.g., IMDB, Kickstarter, Netflix, LinkedIn, etc.) to be scraped for data such as educations, work history, recommendations, credits, accomplishments, awards, affiliations (e.g., studios, professional organizations, etc.). With the wealth of data already existing online, a new user can establish himself or herself on the platform before ever interacting with the platform or its community.

Once an initial reputation has been established, the platform may monitor user activity in a substantially real-time manner or alternatively may store indicative user activity data for later processing. User activity data may also be encrypted/decrypted and/or authenticated to ensure data integrity.

Accordingly, the platform may capture some data points via user input that can be supplemented by colleagues, collaborators and the community at large (in differing degrees of specificity and interaction). The system may also capture a unique data set related projects and platform interaction which may provide insight into a user's level of the expertise, technical proficiency and intangibles (such as reliability, resourcefulness, etc.). This may also include a second layer of scoring data that indicates how collaborators and community members evaluate the users performance on the previous dimensions which will form the foundation for a reputation score. Additionally the platform may provide job related features including but not limited to job postings and job searches. These job related features may be accessed through a user profile via a ‘talent’ feature set.

Comprehensive data from this platform may be factored into a reputation and/or matching program. The reputation element of the algorithm can be estimated by determining which factors from FIG. 2 drive other community members to connect (establish a relationship on the social platform) and collaborate (invite to a specific project). The job matching element of the platform may be estimated by determining which factors drive users seeking talent to connect by establishing a relationship on the social platform and hire by extending an invitation to interview for a temporary of full time job opportunity. Additional dependent outcome variables may include likes and/or upvotes for commentary/annotations, mentor requests/accepts, questions asked/accepted, etc.

The reputation analysis may be conducted as a multivariate Bayesian decision model, a multivariate structural equation model or other similar methods. A structural equation model is a statistical technique for testing and estimating causal relations using a combination of statistical data and qualitative causal assumptions, while a Bayesian model may refer to a a statistical system that tries to quantify the tradeoff between various decisions, making use of probabilities and costs.

Multivariate models involve a number of independent mathematical and statistical variables and the observation and analysis of more than one statistical outcome variable at a time. In design and analysis of a reputation score according to the present disclosure, multivariate technique may be used to perform studies across multiple dimensions (e.g., as shown in FIG. 2) while taking into account the effects of all variables on the responses of interest. The reputation scoring method may also be a dynamic learning model that may change and improve over time by optimizing against outcomes such as contacted to connect on the social platform, contacted to discuss a collaboration opportunity, contacted to discuss a job opportunity, etc.

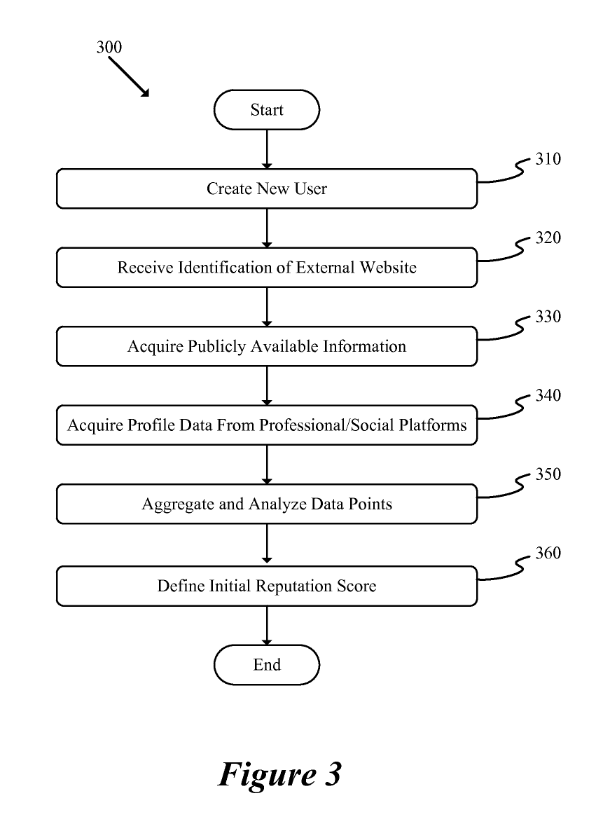

FIG. 3 illustrates a flow chart of an exemplary process used in some embodiments to assess the reputation of a new user on the platform. The process 300 begins with the system creating (at 310) a user account for a new user. Next, the system queries (at 320) the user for external third party websites where relevant data points may be scraped from. This may be in the form of publically available information about the user (e.g. IMDB credits, awards, honors, affiliations, Kickstarter campaigns, etc.) and non-public information from professional and social network sites (e.g., LinkedIn, Facebook, Twitter, etc.).

The process 300 may then scrape (at 330) publically available information. In some embodiments a verification step may take place to establish that the new account creator is in fact the same person from the identified public sites (e.g., by name, email, or other known verification techniques). Next, the process may scrape (at 340) profile data from other third party professional and social networks. To do so, the user may provide login credentials for the websites he wishes to provide data points from, or choose to only use the publically available profile data from such websites. Exemplary data points from external professional and social websites may include education, past work, accomplishments, endorsements, etc.

Once all the data has been gathered from the external websites, the data points are analyzed (at 350). Some embodiments may use a multivariate Bayesian decision model or a multivariate structural equation model to analyze the data sets. Finally, the process 300 will define (at 360) the initial reputation score for the new user. This initial reputation may ease the barrier for new users to join a platform where their established industry reputation may continue to evolve rather than starting from scratch to create a relevant and established profile on the professional platform for content creators as described.

One having ordinary skill in the art would recognize that the scoring and reputation analysis models disclose may be applied to any project based professional environment and that the foregoing examples are merely one use of the disclosed methods for creating a reputation score for content creators. For example, media assets (i.e. content) may extend to work products that can be assessed using defined data points relevant to a particular profession that is based on the creation and work on individual projects. Thus, project based professional may be able to use similar reputation analysis models based on several differing dimensions and variables than those described with relation to a content creation community.

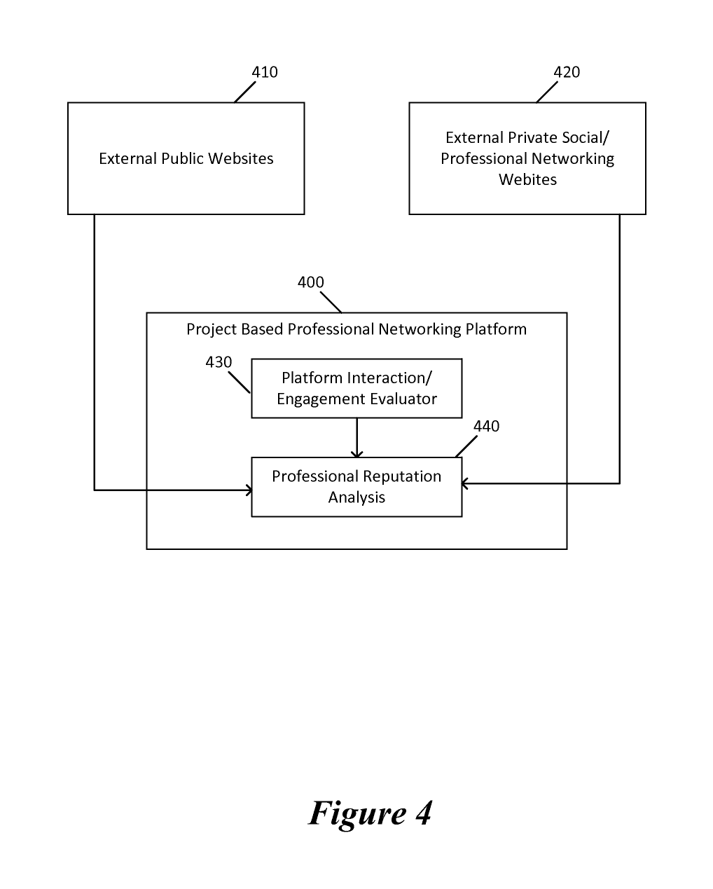

FIG. 4 illustrates a block diagram of data sources used for reputation analysis in a general project based professional networking platform 400. For example, external public websites 410 may be available that provide relevant information about a particular professional. This data may be acquired using web scrapers, bots, or other automated software. Furthermore, external private social and professional networking websites 420 (e.g., LinkedIn, Facebook, Twitter, etc.) may also be a source of further data points that may be useful in evaluating an industry reputation of a professional. In some embodiments, data may be acquired from these external networking sites by scraping profile information that the user has made publicly available. Moreover, when a user provides account credentials for these private networking websites 420 a deeper mining of relevant data points may be accessible. These data points may be acquires using APIs made available by the private social and/or professional networking websites or simple extraction of data using the user provided account credentials. These external sources of data points for evaluation may assist in assessing an initial reputation analysis 440 that can provide recognition for existing work for a user that is new to the project based professional networking platform 400.

Within the project based professional networking platform 400, user interactions and engagement 430 on the platform and with its community may also be evaluated in order to dynamically maintain and update the reputation of an individual professional.

### III. Dynamic Reputation Monitoring

The reputation of content creators on the platform may be dynamically monitored to determine and update a reputation score for each individual as participation in the platform . Community engagement may primarily happen in the form of multimedia annotation created by the content creators in association with projects and video production within the system. These annotations may take the form of text, video, audio, PDF or photos and may be visually represented along a video timeline in the form of various color coded icons representing the type of annotation or role of content creator telling the story (e.g. editor, set designer, etc.) or within a question/answer module on the platform. The annotations may also be commented on by other verified collaborators of the content, peers, the general community on the platform, or public guests viewing the annotations which may further affect the overall reputation of the content creator being commented on.

Other data points that may be continually analyzed may include the creation of new connections, endorsements, question/answers provided, upvotes/likes associated with the user (e.g., project annotations, question/answer, etc.), contributions to the community, number of projects previously and actively engaged in, profile traffic, associated groups and group interactions, etc.

### IV. System Architecture

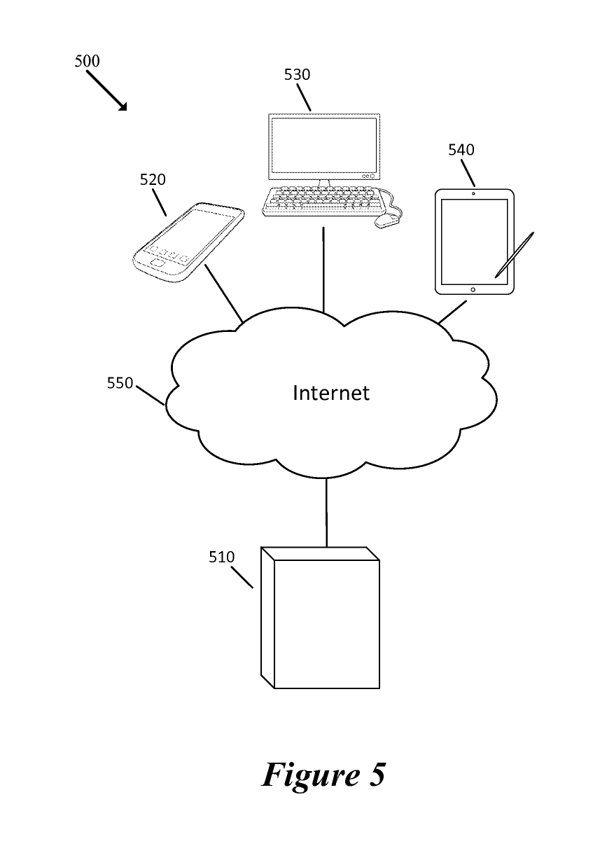

FIG. 5 illustrates an exemplary block diagram of a system 500 for implementing an application that can assess a reputation score for a content creator on the platform of the present disclosure. The system 500 includes a server 510 and one or more electronic devices such as smart phones 520, personal computers (PCs) (e.g., desktops or laptops) 530, and tablets 540. The server 510 provides support for the video player as well as hosting for project content and multi-media annotations via the Internet 550. In some embodiments, users may access the video player on the server 510 and provide multi-media annotations using a browser or application on the electronic devices.

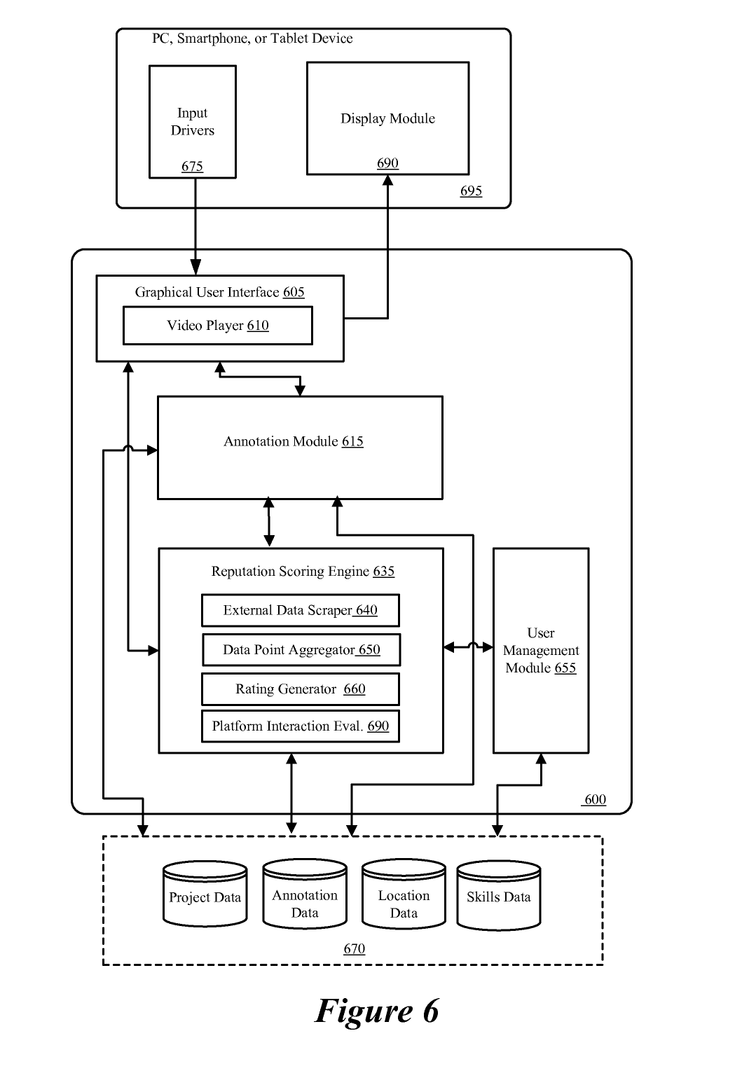

In some embodiments, the above-described operations may be implemented as software running on a particular machine such as a desktop computer, laptop, or handheld device (e.g. smartphone or tablet), or as software stored in a computer readable medium. FIG. 6 illustrates the software architecture of a reputation scoring application 600 in accordance with some embodiments. In some embodiments, the application is a stand-alone application or is integrated into another application (for instance, application 600 might be a portion of a professional network application), while in other embodiments the application might be implemented within an operating system. Furthermore, in some embodiments, the application is provided as part of a server-based (e.g., web-based) solution. In some such embodiments, the application is provided via a thin client. That is, the application runs on a server while a user interacts with the application via a separate client machine remote from the server (e.g., via a browser on the client machine). In other such embodiments, the application is provided via a thick client. That is, the application is distributed from the server to the client machine and runs on the client machine. In still other embodiments, the components (e.g., engines, modules) illustrated in FIG. 6 are split among multiple applications. For instance, in some embodiments, one application may aggregate data to create a reputation scoring tool, while another application maintains annotations and project relationships.

As shown in FIG. 6, the reputation scoring application 600 includes a graphical user interface 605, multimedia annotation module 615, a multivariate reputation scoring engine 635, and user management module 655. The graphical user interface 605 may provide a video player 610 having user-interface tools (e.g., display areas, dock controls, etc.) that a user of the application 600 interacts with in order to view content within the system and to create multimedia annotations in association with the media content being viewed in a main display of the video player 610.

As shown in FIG. 6, the reputation scoring application is provided to facilitate an initial and continued dynamic multivariate reputation score for content creators. The reputation scoring application 600 may include an annotation module 615. In some embodiments, when the user inputs instructions to create annotations to media content, the annotation module 615 may receive and process these instructions in order save and display the annotation in the graphical user interface 605.

As shown in FIG. 6, a multivariate scouting engine 635 of some embodiments includes an external data scraper 640, a data point aggregator 650, a reputation rating generator 660, and a platform interaction evaluation module 690, that may communicate with the multimedia annotation module 615, the graphical user interface 605, a user management module 655, and/or a set of data storages 670 (e.g., project data, annotation data, location data, skills data, etc.). The external data scraper 640 may grab publicly available data about a user as well as private data via public profiles and/or supplied login credential for external professional and social networking sites. Generally, web scraping is a computer software technique of extracting information from websites by simulating human exploration of the World Wide Web. Scraping can transform unstructured data on the web, typically in HTML format, into structured data that can be stored and analyzed in a central local database or spreadsheet. One technique may be related to web automation, which simulates human browsing using computer software. When user credentials are provided for external websites and/or networking platforms, the platform of the current disclosure is given explicit authorization to gather data from external user profiles. In some embodiments, application programming interface commands may be integrated to allow the extraction of particular data points relevant to assessing a reputation score.

The data point aggregator 650 may coming all external data points in the system and the multivariate reputation scoring engine 635 may then be able to parse through the data points and return an initial reputation score calculated by the rating generator 660. As a user interacts with the platform and becomes an active community member, the platform interaction evaluation module 690 may monitor the user's activity and adjust the reputation score based on one or more variables described with reference to FIG. 2.

Electronic devices (e.g., PCs, smartphones, tablets, etc.) 695 used in conjunction with some embodiments include input drivers 675 for allowing the application 600 to receive data from the device so the application 600 can send multimedia content to a display module 690 of the device (e.g., screen or monitor). In some embodiments, the data sent to the device may be sent via a network or over the Internet.

An example operation of the application 600 will now be described by reference to the components (e.g., engines, modules) illustrated in FIGS. 6. A user may interact with user-interface tools (e.g., account creation) in the graphical user interface 605 of the reputation scoring application 600 via input drivers 675 of his device 695 (e.g., a mouse, touchpad, touch screen, etc.) and keyboard (e.g., physical keyboard, virtual keyboard, etc.).

When the user interacts with one or more user-selectable elements (e.g., controls, menu items) in the graphical user interface 605, some embodiments translate the user interaction into input data and send this data to the annotation module 615. The annotation module 615 in some embodiments receives the input data and processes the input data in order to create and save annotations to be associated with media content being displayed in the video player 610. For example, when the annotation module 615 receives instructions for creating an annotation associated with a media clip, the annotation module 615 may process the input data by identifying the portion of media content and type of annotation received, for example, and saves the annotation.

When a user's annotations are saved by the application 600, they can be stored in the set of data storages 670. From the set of data storage 670, the multivariate reputation scoring engine 635 may be able to aggregate several types of data points and generate a reputation rating for display via the graphical user interface 605. The user management module 655 may communicate with the multivariate reputation scoring engine 635 to ensure only reputation scores are attributed to individual profiles on the platform.

It should be recognized by one of ordinary skill in the art that any or all of the components of multivariate reputation scoring software 600 may be used in conjunction with the present disclosure. Moreover, one of ordinary skill in the art will appreciate that many other configurations may also be used in conjunction with the present disclosure or components of the present disclosure to achieve the same or similar results.

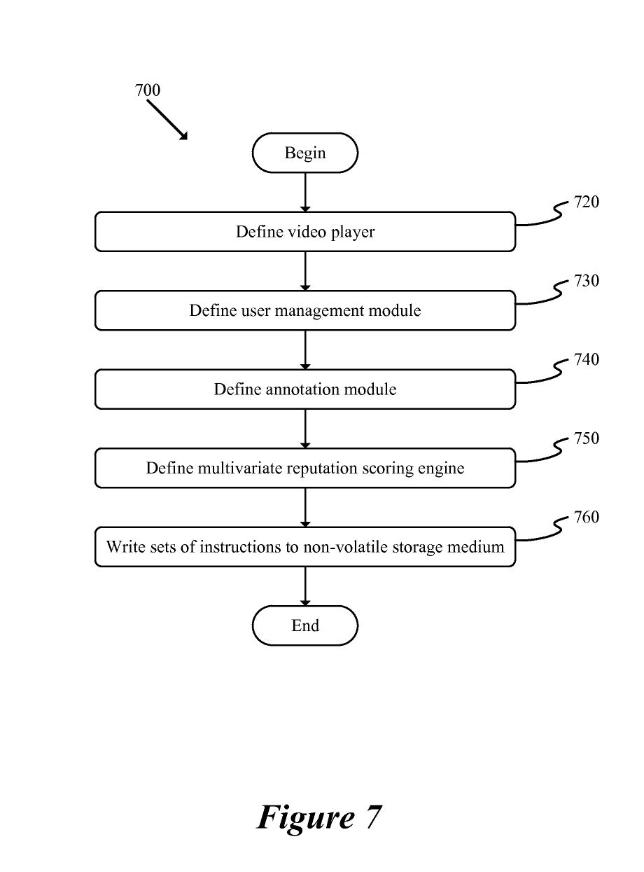

FIG. 7 illustrates a flow chart of a process 700 used by some embodiments to define and store the reputation scoring application of some embodiments. Specifically, process 700 illustrates the operations used to define sets of instructions for providing several of the elements described above in FIG. 6 and for creating a video player 610 with annotation capabilities, a user management module 655, an annotations module 615, and the multivariate reputation scoring engine 635. The process 700 may be used to generate a reputation scoring application of some embodiments.

Process 700 may begin with the generation of a computer program product for use by consumers. As shown, the process may define (at 720) sets of instructions for implementing a video player having annotation capabilities. In some cases such sets of instructions are defined in terms of object-oriented programming code. For example, some embodiments may include sets of instructions for defining classes and instantiating various objects at runtime based on the defined classes.

Next, process 700 defines (at 730) sets of instructions for a user management module (e.g., for managing curators, content creators, general public, etc.). Process 700 then defines (at 740) sets of instructions for defining an annotation module for the content creator.

Then process 700 defines (at 750) sets of instructions for implementing a multivariate reputation scoring engine (e.g., as described above in reference to FIG. 3). Finally, the process writes (at 760) the sets of instructions to a storage medium such as, but not limited to, a non-volatile storage medium. One of ordinary skill in the art will recognize that the various sets of instructions defined by process 700 are not exhaustive of the sets of instructions that could be defined and stored on a computer readable storage medium for a reputation scoring application incorporating some embodiments of the disclosure. In addition, the process 700 is an exemplary process, and the actual implementations may vary. For example, different embodiments may define the various sets of instructions in a different order, may define several sets of instructions in one operation, may decompose the definition of a single set of instructions into multiple operations, etc. In addition, the process 700 may be implemented as several sub-processes or combined with other operations within a macro-process.

### V. Computer System

Many of the processes and modules described above may be implemented as software processes that are specified as at least one set of instructions recorded on a non-transitory storage medium. When these instructions are executed by one or more computational elements (e.g., microprocessors, microcontrollers, Digital Signal Processors (“DSPs”), Application-Specific ICs (“ASICs”), Field Programmable Gate Arrays (“FPGAs”), etc.) the instructions cause the computational element(s) to perform actions specified in the instructions.

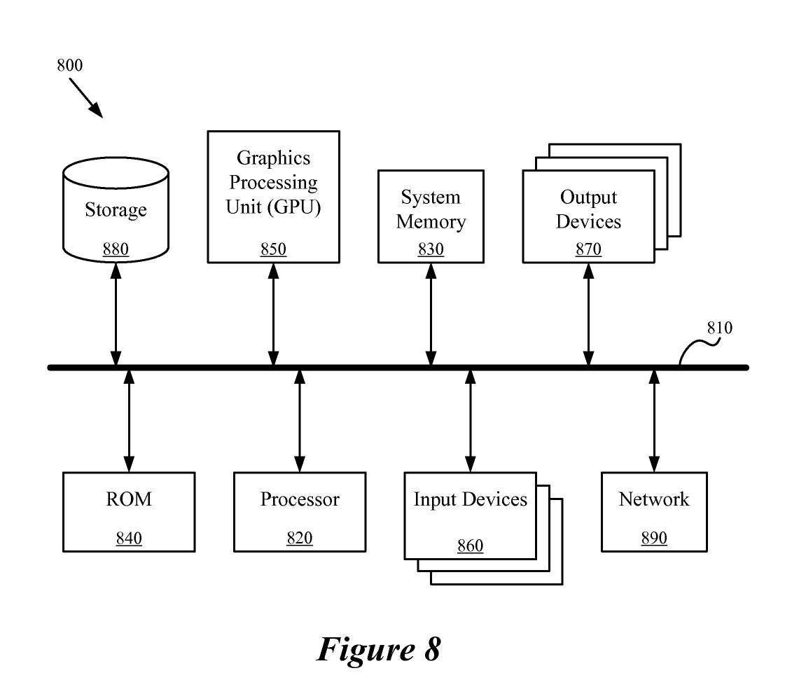

FIG. 8 illustrates a schematic block diagram of a computer system 800 with which some embodiments of the disclosure may be implemented. For example, the system described above in reference to FIG. 1 may be at least partially implemented using computer system 800. As another example, the processes described in reference to FIG. 3 may be at least partially implemented using sets of instructions that are executed using computer system 800.

Computer system 800 may be implemented using various appropriate devices. For instance, the computer system may be implemented using one or more personal computers (“PC”), servers, mobile devices (e.g., a Smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

Computer system 800 may include a bus 810, at least one processing element 820, a system memory 830, a read-only memory (“ROM”) 840, other components (e.g., a graphics processing unit) 850, input devices 860, output devices 870, permanent storage devices 880, and/or a network connection 890. The components of computer system 800 may be electronic devices that automatically perform operations based on digital and/or analog input signals.

Bus 810 represents all communication pathways among the elements of computer system 800. Such pathways may include wired, wireless, optical, and/or other appropriate communication pathways. For example, input devices 860 and/or output devices 870 may be coupled to the system 800 using a wireless connection protocol or system. The processor 820 may, in order to execute the processes of some embodiments, retrieve instructions to execute and data to process from components such as system memory 830, ROM 840, and permanent storage device 880. Such instructions and data may be passed over bus 810.

ROM 840 may store static data and instructions that may be used by processor 820 and/or other elements of the computer system. Permanent storage device 880 may be a read-and-write memory device. This device may be a non-volatile memory unit that stores instructions and data even when computer system 800 is off or unpowered. Permanent storage device 110 may include a mass-storage device (such as a magnetic or optical disk and its corresponding disk drive).

Computer system 800 may use a removable storage device and/or a destination storage device as the permanent storage device. System memory 830 may be a volatile read-and-write memory, such as a random access memory (“RAM”). The system memory may store some of the instructions and data that the processor uses at runtime. The sets of instructions and/or data used to implement some embodiments may be stored in the system memory 830, the permanent storage device 880, and/or the read-only memory 840. For example, the various memory units may include instructions for authenticating a client-side application at the server-side application in accordance with some embodiments. Other components 850 may perform various other functions. These functions may include interfacing with various communication devices, systems, and/or protocols.

Input devices 860 may enable a user to communicate information to the computer system and/or manipulate various operations of the system. The input devices may include keyboards, cursor control devices, audio input devices and/or video input devices. Output devices 870 may include printers, displays, and/or audio devices. Some or all of the input and/or output devices may be wirelessly or optically connected to the computer system.

Finally, as shown in FIG. 8, computer system 800 may be coupled to a network through a network adapter 890. For example, computer system 800 may be coupled to a web server on the Internet such that a web browser executing on computer system 800 may interact with the web server as a user interacts with an interface that operates in the web browser.

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 800 may be used in conjunction with the disclosed embodiments. Moreover, one of ordinary skill in the art will appreciate that many other system configurations may also be used in conjunction with the disclosed embodiments or components of the embodiments.

Moreover, while the examples shown may illustrate many individual modules as separate elements, one of ordinary skill in the art would recognize that these modules may be combined into a single functional block or element. One of ordinary skill in the art would also recognize that a single module may be divided into multiple modules.

While the disclosure has been described with reference to numerous specific details, one of ordinary skill in the art will recognize that the disclosure can be embodied in other specific forms without departing from the scope of the disclosure. For example, several embodiments were described above by reference to particular features and/or components. However, one of ordinary skill in the art will realize that other embodiments might be implemented with other types of features and components, and that the disclosure is not to be limited by the foregoing illustrative details.

What is claimed is:

1. A method for establishing a reputation score comprising:
creating (310) a new user account;
receiving (320) an identification of external data repositories, wherein the external data repositories comprise public and private data points about the user;
acquiring (330) publicly available information about the user from external data repositories;
acquiring (340) profile data from private external data repositories, wherein the private external data repositories require account information for accessing profile data of the user;
aggregating (350) the publicly available information and profile data into a plurality of data points;
analyzing (350) the data points; and
defining (360) a reputation score based on the analyzed data points.

2. The method of claim 1, wherein a source of public ally available information about the user is the Internet Movie Database.

3. The method of claim 2, wherein data points from the Internet Movie Database comprise filmography credits, awards, and nomination information.

4. The method of claim 1, wherein a source of public ally available information about the user comprises public profiles on social networking websites.

5. The method of claim 1, wherein a source of publically available information about the user comprises public profiles on professional networking platforms.

6. The method of claim 1, wherein application programming interface specify data points available in private external data repositories.

7. The method of claim 1, wherein the analyzing is accomplished using at least one of a Bayesian decision model, a structural equation model, and a multivariate model.

8. An apparatus for assessing a reputation score of a professional on a project based networking platform comprising:
a storage (880) for storing data points associated with a user;
a memory (830) for storing sets of instructions;
a processor (820) for executing the sets of instructions, wherein the processor:
creates (310) a new user account;
receives (320) an identification a plurality of data points, wherein the data points are gathered from a plurality of external public and private data repositories;
analyzes (350) the data points; and
determines (360) a reputation score based on the analyzed data points.

9. The apparatus of claim 8, wherein a publically available data points include filmography credits, awards, and nominations.

10. The apparatus of claim 8, wherein privately available data points are acquired via application interface programming which provide external social and professional networking platforms.

11. The apparatus of claim 8, wherein the determining uses a Bayesian decision model.

12. The apparatus of claim 8, wherein the determining uses a structural equation model.

13. The apparatus of claim 8 further comprising dynamically updating the reputation score based on user interactions within the project based platform.

14. A non-transitory computer readable medium storing a reputation scoring application within a content creator networking platform, the reputation scoring application for execution by at least one processor, the reputation scoring application comprising sets of instructions for:
Defining (720) a video player, wherein the video player comprises controls for creating annotations to content being viewed in the video player;
defining a user management (730) module for managing content creators;
defining an annotation module (740) for creating annotations in association with the content; and
defining (750) a reputation scoring engine for analyzing external and internal data points to determine a reputation score for each content creator.

15. The non-transitory computer readable storage medium of claim 14, wherein the reputation scoring engine further comprises an external data scraper for acquiring data from external platforms, wherein the external platforms comprise public filmography repositories.

16. The non-transitory computer readable storage medium of claim 15, wherein the external platforms further comprise private social and professional networking platforms accessible with user account credentials.

17. The non-transitory computer readable storage medium of claim 14, wherein the reputation scoring engine further comprises a data point aggregator for combining data received from external public and private platforms.

18. The non-transitory computer readable storage medium of claim 14, wherein the reputation scoring engine further comprises a rating generator for assessing a reputation score based on the aggregated data points.

19. The non-transitory computer readable storage medium of claim 14, wherein the reputation scoring engine further comprises a platform interaction evaluator for dynamically adjusting a reputation score based on user interaction within the content creator networking platform.

20. The non-transitory computer readable storage medium of claim 19, wherein data points gathered by the platform interaction evaluator comprise content contributed by the user and community feedback associated with the content.
